(19) United States
(12) Patent Application Publication
(10) Pub. No.: US 2015/0195764 A1
(43) Pub. Date: Jul. 9, 2015

(54) NETWORK SERVICE SYSTEM AND METHOD FOR PROVIDING NETWORK SERVICE IN MULTIPLE MOBILE NETWORK ENVIRONMENT

(71) Applicant: Electronics and Telecommunications Research Institute, Daejeon (KR)

(72) Inventors: Hyung Seok CHUNG, Daejeon (KR); Ho Young SONG, Daejeon (KR); Don Sung OH, Daejeon (KR); Kyung Gyu CHUN, Daejeon (KR); Yeong Jin KIM, Daejeon (KR); Ho Yong RYU, Daejeon (KR); Chie Teuk AHN, Seoul (KR)

(21) Appl. No.: 14/591,195

(22) Filed: Jan. 7, 2015

(30) Foreign Application Priority Data
Jan. 7, 2014 (KR) 10-2014-0001738
Nov. 18, 2014 (KR) 10-2014-0161112

(51) Int. Cl. H04W 40/02

(52) U.S. Cl. CPC H04W 40/02; H04W 80/04

(57) ABSTRACT

Disclosed is a network service system including a terminal selectively providing packets of an information centric networking (ICN) protocol and an Internet protocol, a smart digital unit (DU) identifying whether the packets provided from the terminal correspond to an ICN protocol packet or an Internet protocol packet to transfer the packets through different paths depending on a type of the identified packet, and an ICN node receiving the ICN protocol packet from the smart DU to provide contents.

### CROSS-REFERENCE TO RELATED APPLICATIONS

This application claims priority to and the benefit of Korean Patent Application No. 10-2014-0001738 filed in the Korean Intellectual Property Office on Jan. 7, 2014, and Korean Patent Application No. 10-2014-0161112 filed in the Korean Intellectual Property Office on Nov. 18, 2014, the entire contents of which are incorporated herein by reference.

### TECHNICAL FIELD

The present invention relates to a system and a method for providing a network service in an environment in which a mobile communication network and an information centric network (hereinafter, referred to as ICN) coexist in order to transfer various media data including large-capacity streaming data to a user more rapidly.

### BACKGROUND ART

An ICN is a future network technology that finds and transfers desired information by using a name of data (alternatively, contents) instead of an IP address used in a current IP network.

A concept of the ICN has been used as a concept similar to Named Data Network (NDN), Content-Centric Network (CCN), Data-Oriented Network Architecture (DONA), Publish-Subscribe Internet (PSI), Network of Information (NetInf), and the like in various research projects of U.S.A. and EU. The ICN and the NDN, the CCN, the DONA, the PSI, the NetInf, and the like are slightly different from each other in terms of a detailed technology, but are the same as each other in terms of an oriented goal.

In a current Internet structure which is mainly constituted by an IP based client-server model or peer-to-peer communication, a one-to-one transmission paradigm is followed, in which both ends participate in communication construct an interconnection relationship and thereafter, transmit an IP data packet. The current Internet structure has a limit in terms of extensibility, security, and the like.

On the contrary, the ICN that aims at the future Internet structure is a network which focuses on “what”, that is, information having a key meaning in constructing an application with a user. The ICN changes a current communication paradigm that focuses on “where” such as an address, a server, a host, and the like.

In other words, instead of designating a position for acquiring information like the IP address, the ICN grants a unique identifier or name to information to acquire desired information from the closest and quickest place regardless of a position by considering information as a top independent main agent.

A current mobile communication network introduces a mobile CDN technology in order to increase content transfer efficiency. The mobile CDN technology positions a cache server at a base station terminal that is close to the user and stores data of a contracted service/content provider in the cache server in advance to transfer the contents to the user rapidly.

The mobile CDN technology may provide a more rapid data service through user approach transmission, but the provided data is limited to not general Internet contents but contracted contents, and a deep packet inspection (DPI) server is present at a back end of a packet gateway (PGW) of the mobile communication network to monitor a user request packet and determine whether desired contents are stored in a cache to cope with the determination.

Meanwhile, since the ICN seeks network level content transfer, the ICN is different from the mobile CDN technology that performs server (alternatively, service) level content transfer which is irrespective of the network. In the network level content transfer technology, the network may select and process an optimal content transfer method by considering a network state (a load, a bandwidth, a transfer path, and the like) of itself, and the server and the network are integrated to increase efficiency such as performance, CAPEX, OPEX, and the like and consequently, assist in improving profitability of a communication provider.

### SUMMARY OF THE INVENTION

The present invention has been made in an effort to provide a network service system and a network service method that can increase a transfer speed and processing efficiency of data by applying an ICN technology in an environment in which a mobile communication network is constructed.

The technical objects of the present invention are not limited to the aforementioned technical objects, and other technical objects, which are not mentioned above, will be apparent to those skilled in the art from the following description.

An embodiment of the present invention provides an ICN including a terminal providing both an ICN protocol and an Internet protocol, a smart DU capable of identifying and processing an ICN protocol packet and an Internet protocol packet, an ICN node (performs a data plane function of network equipment) capable of transmitting an ICN packet, and an ICN platform (provides a control/management plane function of the network equipment and an ICN-API to a higher application) controlling the ICN node.

In detail, in the network service system according to the embodiment of the present invention, the terminal may selectively provide packets of an ICN protocol and an Internet protocol and the smart DU identifies whether the packets provided from the terminal correspond to an ICN protocol packet or an Internet protocol packet to transfer the packets through different paths depending on a type of the identified packet. The ICN node may receive the ICN protocol packet from the smart DU to provide contents to the terminal.

According to the embodiments, in an environment in which a mobile communication network and an ICN coexist, the terminal may use both networks or singly use each of the networks.

In the embodiment, when a power supply of the terminal is turned on, the terminal and the smart DU cooperate with each other to determine whether to access the ICN. To this end, the smart DU or a mobile communication base station may provide to the corresponding terminal information regarding whether to be accessible to the ICN and information on a reference to receive the ICN service.

When there is no ICN node in a base station (alternatively, a station), the terminal accesses the existing mobile communication network to use an IP service. When the terminal moves to access another base station equipment and use the ICN, the smart DU or the mobile communication base station provides to the terminal the information regarding whether to be accessible to the ICN and the information on the reference to receive the ICN service.

The terminal cooperates with the ICN node or an Internet server to determine whether to use the ICN, whether to use the mobile communication network, or whether to sequentially use both networks depending on a capacity, a type, a use frequency, and the like of the contents according to the reference.

Reference information required for determining which network is used is acquired through interaction between the terminal and the ICN node, between the terminal and service servers (e.g., portal servers including Naver, Google, YouTube, and like), between the terminal and the smart DU in the base station, and the like.

The network selection reference information may be singly determined based on a record that the terminal used the network previously.

Information transferred through the ICN basically includes all types, but the ICN may be preferentially used in order to acquire specific type of information according to a policy of the terminal.

The network selection reference of the terminal may include as the determination reference the size of the information, an ICN name or the presence of an ID or not, a service type such as a real-time service, and the like in addition to the type of the information.

For example, when the mobile communication network and the ICN coexist, personal generation information without the ID is generally communicated through the mobile communication network.

The case where the ICN name or the ID exists is a case where there is a high probability that the corresponding information is information which is frequently used.

Another embodiment of the present invention provides a network service method including: requesting, by a terminal, contents by selectively using packets of an information centric networking (ICN) protocol and an Internet protocol; identifying a type of the packet provided from the terminal; transferring the packet to the ICN when the packet is an ICN protocol packet and the packet to a mobile communication network when the packet is an Internet protocol packet; and transferring the contents requested by the terminal in response to the transferred packet.

According to embodiments of the present invention, provided are a network service system and a network service method that apply an ICN technology to a mobile communication network, and interlock a terminal and an ICN with each other to improve a transfer speed and processing efficiency of data. In particular, when a capacity of data is large like video data of which a half or more is occupied by mobile traffic, an effect of the present invention can be maximized.

According to a configuration of the present invention, the existing mobile communication network and a new ICN can be operated in parallel, and when a name based forwarding information transfer service is provided on a mobile ICN, a terminal, ICN components, a service server, and the like are interlocked with each other to determine whether to use the ICN when the terminal is turned on or moves from a mobile region.

When the terminal requests specific information (alternatively, contents), the terminal determines whether to receive the information through the ICN or the mobile communication network to request the specific information and in this case, the terminal may set a determination reference (for example, large-capacity data, a data type, a data name, or the presence of an ID or not, a service type, and the like) to select a network to be used.

A mobile terminal user may use high-value and high-quality services such as a large-capacity high-definition streaming service and a low-delay real-time on-line game of which the service is unavailable in the related art through the present invention and a communication provider and a service provider may create profits by extending a new service. Further, cost for network installation and operation can be saved by preventing duplicate transmission of large-capacity contents and simplifying a name based content transmission mechanism.

The embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the embodiments of the present invention. It can be easily known that the objects and advantages of the present invention can be implemented by the means and a combination thereof described in the appended claims.

### BRIEF DESCRIPTION OF THE DRAWINGS

FIG. 1 is a diagram for describing a mobile ICN service according to an embodiment of the present invention.

FIG. 2 is a diagram illustrating a protocol stack of a mobile terminal according to an embodiment of the present invention.

FIG. 3 is a flowchart for describing a network service method according to another embodiment of the present invention.

FIG. 4 is a block diagram illustrating a terminal according to the embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, embodiments of the present invention will be described in detail with reference to the accompanying drawings. Like reference numerals refer to like elements in the drawings and a duplicated description of like elements will be skipped.

Regarding the embodiments of the present invention disclosed in the specification, specific structural or functional descriptions are exemplified to describe the embodiment of the present invention and the embodiments of the present invention may be carried out in various forms and it should not be analyzed that the present invention is limited to the embodiments described in the specification.

Terms such as first, second, and the like may be used in describing the components of the embodiments according to the present invention. The terms are only used to distinguish a constituent element from another constituent element, but nature or an order of the constituent element is not limited by the terms.

The present invention provides a method and a system which can operate the existing mobile communication network and a new ICN in parallel, and a method and a system in which a terminal, ICN components, a server, and the like interlock with each other at the time of providing a name based information transfer service on a mobile ICN to determine whether to use the ICN when the terminal is turned on or moves from a mobile region.

The present invention proposes a method for configuring an independent ICN by distributing ICN nodes to base station terminals (BS-DU equipment position) positioned at a station and connecting nodes thereof with each other on a mobile communication network for each communication provider and a method for allowing the terminal to simultaneously use the existing Internet service and an ICN service.

There is provided a method in which when the terminal requests specific information (alternatively, contents), the terminal determines whether to receive the information through the ICN or the mobile communication network and in this case, a determination reference (for example, large-capacity data, a data type, a data name, or the presence of an ID or not, a service type, and the like) for the terminal to select a network may be provided.

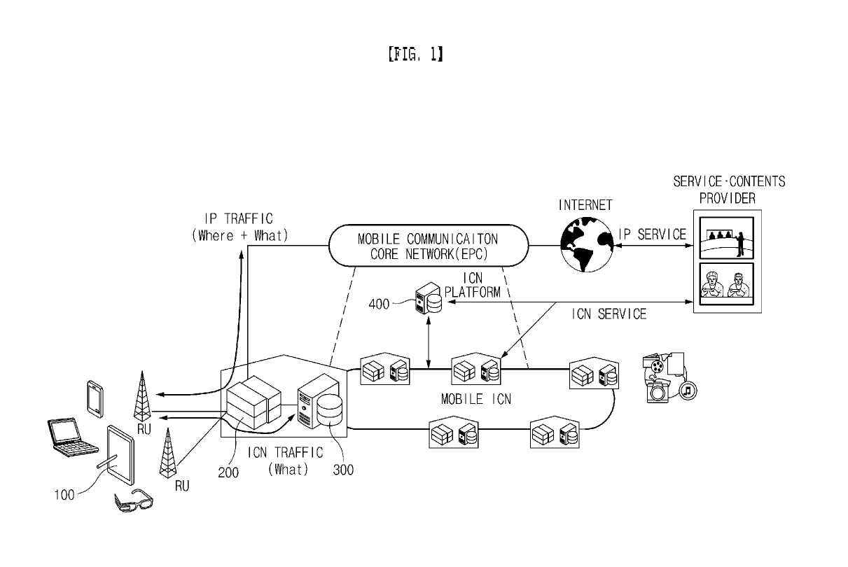

FIG. 1 is a diagram for describing a mobile ICN service according to an embodiment of the present invention.

Referring to FIG. 1, the mobile ICN service is provided through a mobile ICN and an IP service is provided through the existing mobile communication network. The mobile ICN may be configured to include a terminal 100, a smart digital unit (DU) 200, an ICN node 300, and an ICN platform 400.

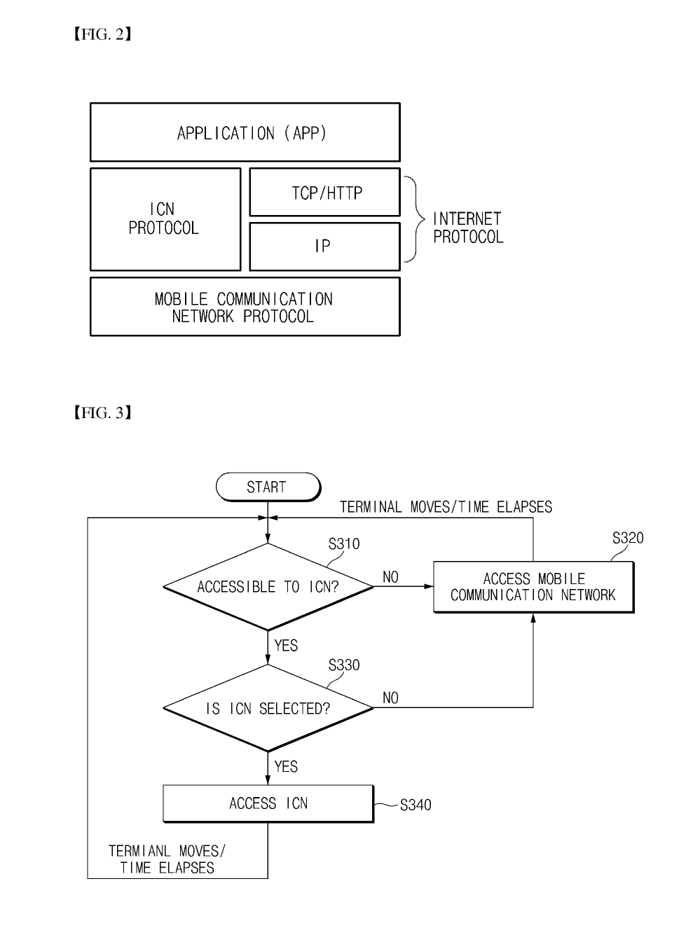

The terminal 100 is a terminal capable of mobile communication and wireless communication, which includes both an IP based mobile communication protocol and an ICN protocol. A radio air section may use an MAC/PHY communication protocol commonly or by different access methods for IP communication and ICN communication. The protocol used by the terminal 100 will be described in more detail with reference to FIG. 2.

The smart DU 200 performs a function of a digital unit (DU) of base station equipment. The smart DU 200 identifies a packet type of the terminal 100 in addition to the existing mobile communication function to generate and manage an IP based GPRS tunneling protocol (GTP) for each user terminal to transfer a packet depending on the identified packet type.

In detail, the smart DU 200 identifies whether the protocol provided from the terminal 100 is the ICN protocol or the Internet protocol to transfer the packet through different paths depending on the identified packet type. For example, when the smart DU 200 identifies that the packet provided from the terminal 100 is the ICN packet, the smart DU 200 bypasses the packet to the ICN node 300. When the protocol provided from the terminal 100 is identified as the Internet protocol, the packet may be provided through the existing mobile communication network.

In some embodiments, the smart DU 200 may collect traffic usage for each terminal 100 and provide charging information as necessary.

The ICN node 300 is network equipment that performs packet forwarding based on a name (alternatively, a unique ID). An operating mechanism of name based information transfer is substantially the same as CCN, ICN, and NDN technologies and basically includes a content caching function. Accordingly, a detailed description thereof will be omitted.

The ICN node 300 proposed in the present invention further includes a caching and storing function and newly generated original contents are stored in and distributed to one node of the distributed ICN nodes 300 according to a policy of the ICN platform 400.

The smart DU 200 may be configured in an intelligent ICN base station. The ICN node 300 may be distributed and disposed in a part of the ICN according to management of the ICN platform 400. Accordingly, the ICN node 300 may be included in some base stations of base stations accessed by the terminal 100, but the ICN node 300 may not be included in some base stations.

The ICN platform 400 performs a network management plane function such as collection of the traffic usage, node state/performance information in addition to a network control plane function such as name based routing.

The ICN platform 400 generates name based routing table (routing information base (RIB)) information based on a state of the node and topology information, and generates and issues name based forwarding (forwarding information base (FIB)) information required for each ICN node 300 based thereon. Further, the ICN platform 400 provides an API to a service provider (service/content provider) using the ICN to generate name based information and store and manage the generated information in the mobile ICN.

The embodiment of the network service according to the present invention will be described below.

When a plurality of viewers watches World Cup football games through the mobile communication terminal, if terminals are connected to a relay server through a PGW by a current mobile communication tunneling scheme, enormous network traffic may be generated. Accordingly, a considerable network problem may be caused.

According to the present invention, a content ID (alternatively, name) for a football game provided to the terminal is present, and as a result, football game contents may be provided to numerous terminals through the ICN. In this case, the generation of the traffic in the network is just present only between the user terminal 100 and the smart DU 200. Accordingly, in the network service according to the present invention, a traffic problem does not occur in a mobile communication backhaul and core network section.

FIG. 2 is a diagram illustrating a protocol stack of a terminal for providing a network service according to an embodiment of the present invention.

Referring to FIG. 2, the terminal 100 includes dual protocol stacks for simultaneously supporting the ICN service and the IP based mobile communication service.

The protocol stack of the terminal 100 may include a mobile communication protocol including a PHY layer and an MAC layer, an Internet protocol such as the existing IP and TCP/HTTP on a higher layer thereof, and an ICN protocol on the same layer as the Internet protocol.

The terminal 100 may select whether to use the IP and TCP/HTTP protocol, that is, the Internet protocol or whether to use the ICN protocol. The protocol may be selected when a power supply of the terminal 100 is turned on, when the terminal 100 moves to be connected with another base station, or at a predetermined time interval. In some embodiments, if it may not be sensed that the terminal 100 is connected with another base station, when the terminal 100 moves a predetermined distance or more, a protocol to be used may be selected again.

In some embodiments, the terminal 100 may determine whether to receive the service through the ICN node 300 in cooperation with the ICN node 300, the smart DU 200, or an Internet server illustrated in FIG. 1 constituting the base station. For example, the terminal 100 may select the protocol based on a type of information or contents, a name of information or contents requested by the terminal 100 or presence of an ID or not.

In another embodiment, the terminal 100 may use the protocol so as to accumulate and store previous service use records and receive a service frequently used in the terminal 100 based on the stored use records. In yet another embodiment, the terminal 100 may internally store a reference for using a specific service and select the protocol according to the stored reference.

Since different networks are used through the smart DU 200 according to the protocol selected by the terminal 100, the selection of the protocol by the terminal 100 may be appreciated as the same concept as selecting a used network.

Hereinafter, a method for determining the protocol used by the terminal 100 will be described in detail with reference to the accompanying drawings.

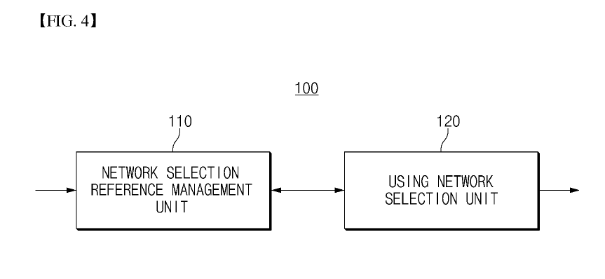

FIG. 3 is a flowchart for describing a network service method according to another embodiment of the present invention.

The network service method according to the embodiment of the present invention may include requesting, by the terminal, information or contents by selectively using the packets of the ICN protocol and the Internet protocol, transferring, by the ICN node 300, the packet through the ICN when a type of a packet provided from the terminal is identified to be the ICN protocol packet and the packet through the mobile communication network when the packet is identified to be the Internet protocol packet, and transferring contents requested by the terminal 100 in response to the transferred packet.

In detail, in FIG. 3, it is, in detail, illustrated whether the terminal 100 requests the contents by selecting one protocol of the Internet protocol and the ICN protocol.

When the terminal 100 is initialized like the case where the power supply of the terminal 100 is turned on, the terminal 100 determines whether to be accessible to the ICN (step S310). When the access itself to the ICN is unavailable, for example, when the ICN node 300 is not provided in the base station accessed by the terminal 100 (step S310, No), the terminal 100 accesses the mobile communication network by using the Internet protocol (step S320).

Although the terminal 100 accesses the mobile communication network, when the terminal moves to access another base station as described above or a predetermined time elapses, it may be determined again whether to be accessible to the ICN.

When the terminal 100 is accessible to the ICN (step S310, Yes), it is determined whether to use the ICN service (step S330). Since there may be contents suitable for using the mobile communication network even though the terminal 100 may use the ICN, it is determined once more whether to use the ICN protocol.

For example, when personal information or contents or a voice service (e.g., VoIP) in which a lot of traffic is not generated is used, it is anticipated that the ICN will not be able to completely substitute for a role of the mobile communication network for a considerable long time. Therefore, when the ICN is used at the time of receiving the voice service for the first time, in the case where the terminal moves to a region where the ICN node 300 is not installed, a problem that the service is interrupted may be incurred. As a result, in the present invention, it may be advantageous to use the existing mobile communication network for the voice service or private personal information without an ICN ID.

Although the terminal 100 may use the ICN as described above, the terminal 100 may select a protocol different from the Internet protocol according to a type of a specific service.

In some embodiments, the terminal 100 is interlocked with the smart DU 200, the ICN node 300, or the Internet server provided in the base station to acquire a selection reference of a network used by the terminal 100.

The terminal 100 selects a protocol to be used according to the acquired network selection reference. For example, the protocol used by the terminal 100 may select according to at least one reference of a capacity, a type, the presence of the ICN ID, and a use frequency of requested information or contents.

For example, contents of personal information without the ID are acquired by using the Internet protocol and when the size of the contents is large, mobile communication network traffic may be reduced in the case of using the ICN protocol.

According to some embodiments, the terminal 100 may select the protocol to be used based on a previous network selection record. The protocol is provided to the smart DU 200 by selecting a protocol of which a use frequency is high previously to receive the contents more efficiently.

When the terminal 100 determines that it is appropriate to use the ICN protocol (step S330, Yes), the terminal 100 accesses the ICN (step S340). As described above, the terminal 100 provides the ICN protocol packet to the smart DU 200 and the smart DU 200 transfers the packet to the ICN node 300 to access the ICN.

The ICN node 300 may provide temporarily stored contents or contents received from another ICN node to the terminal 100 immediately.

When the terminal 100 determines that it is appropriate to receive the corresponding contents by using the Internet protocol (step S330, No), the terminal 100 selects the contents to use the Internet protocol and transfers the Internet protocol packet to the smart DU 200 to access the mobile communication network (step S320).

Even after the terminal 100 accesses the ICN, when the terminal moves a predetermined distance or more, or a predetermined time or more elapses, or the terminal 100 accesses another base station, the terminal 100 may determine whether to use the ICN again.

FIG. 4 is a block diagram illustrating a terminal according to the embodiment of the present invention.

Referring to FIG. 4, the terminal 100 may include a network selection reference management unit 110 and a using network selection unit 120.

The network selection reference management unit 110 may acquire a reference regarding network selection of the terminal 100 from the ICN node 300, the smart DU 200, the base station, or the Internet server. The network selection reference may be based on various schemes as described above.

The using network selection unit 120 may select the protocol to be used by the terminal 100 according to the network selection reference. According to the embodiment, the using network selection unit 120 may select the used network according to the network selection reference which is based on the capacity, the type, and the like of the contents requested by the terminal 100. For example, the network selection reference may be allowed to select the used network according to a calculated numerical value calculated by granting a priority or a weighted value to various factors.

In another embodiment, the using network selection unit 120 may select a used network of which a use frequency is relatively high based on network selection record information. Preference data of a user of the terminal 100 may be reflected on the previous network selection record. Accordingly, regardless of the type or capacity of the contents, the using network selection unit 120 may select a used network which is comparatively frequently used by the terminal 100 before.

In the network service system and the network service method according to the embodiments of the present invention, the terminal 100 that may simultaneously use the Internet protocol and the ICN protocol selectively transmits the protocol packet and the smart DU 200 transfers the packet through different paths by determining a type of the received packet to simultaneously use the existing mobile communication network and the ICN. Both networks may be simultaneously used as described above to cope with an increase in traffic and achieve gradual conversion into the ICN while using a mobile communication network which is already constructed.

Although the present invention described as above is not limited by the aforementioned embodiments and the accompanying drawings and it will be apparent to those skilled in the art that various substitutions, modifications, and changes can be made within the scope without departing from the technical spirit of the present invention.

What is claimed is:

1. A network service system comprising:
a terminal configured to provide packets of an information centric networking (ICN) protocol and an Internet protocol selectively;
a smart digital unit (DU) configured to identify whether the packets provided from the terminal correspond to an ICN protocol packet or an Internet protocol packet and to transfer the packets through different paths depending on a type of the identified packet; and
an ICN node configured to receive the ICN protocol packet from the smart DU and to provide contents.

2. The network service system of claim 1, wherein the terminal selects whether to use the ICN protocol or the Internet protocol based on at least one of a capacity, a type, and a use frequency of the contents.

3. The network service system of claim 1, wherein when the smart DU identifies that the packet provided from the terminal is the ICN protocol packet, the smart DU bypasses the ICN protocol packet to the ICN node and when the smart DU identifies that the packet is the Internet protocol packet, the smart DU transfers the packet provided from the terminal to the mobile communication network.

4. The network service system of claim 1, wherein the terminal includes:
a network selection reference management unit configured to acquire a network selection reference from the ICN node or the smart DU; and
a using network selection unit configured to select the protocol to be used based on the network selection reference.

5. The network service system of claim 4, wherein the using network selection unit selects a protocol to be used based on a previous network selection record of the terminal.

6. The network service system of claim 4, wherein the using network selection unit receives information regarding whether to be accessible to the ICN from the smart DU or a base station.

7. The network service system of claim 4, wherein the using network selection unit selects a protocol to be used again when a power supply of the terminal is turned on.

8. The network service system of claim 1, wherein the ICN node performs caching and storage functions of contents to be provided to the terminal.

9. The network service system of claim 1, further comprising:
an ICN platform configured to collect and manage state and performance information of the ICN node and generate name based forwarding (forwarding information base) information required for the ICN node.

10. A network service method comprising:
requesting, by a terminal, contents by using packets of an information centric networking (ICN) protocol and an Internet protocol selectively;
identifying a type of the packet provided from the terminal;
transferring the packet to the ICN when the packet is an ICN protocol packet and to a mobile communication network when the packet is an Internet protocol packet; and
transferring the contents requested by the terminal in response to the transferred packet.

11. The network service method of claim 10, wherein the requesting, by the terminal, of the contents includes determining whether the terminal is capable of using the ICN in link with a base station connected with the terminal.

12. The network service method of claim 11, wherein when the case where the base station connected with the terminal is changed, and the terminal moves a predetermined distance or more or a predetermined time elapses after the content are requested;
determining again whether the terminal is capable of using the ICN in link with the base station connected with the terminal.

13. The network service method of claim 11, further comprising:
receiving, by the terminal, information regarding whether to be accessible to the ICN from the base station.

14. The network service method of claim 10, wherein the requesting, by the terminal, of the contents includes selecting whether to use the ICN protocol or the Internet protocol based on at least one of a capacity, a type, and a use frequency of the contents.

15. The network service method of claim 14, wherein when no identification (ID) is present in the contents requested by the terminal, the Internet protocol is used.
